(19) United States
(12) Patent Application Publication
(10) Pub. No.: US 2016/0226742 A1
(43) Pub. Date: Aug. 4, 2016

(54) MONITORING NETWORK PERFORMANCE CHARACTERISTICS

(71) Applicants: Ramasamy APATHOTHARANAN, Bangalore (IN); Venkatavaradhan DEVARAJAN, Bangalore (IN); HEWLETT-PACKARD DEVELOPMENT COMPANY, L.P., Houston, TX (US)

(72) Inventors: RAMASAMY APATHOTHARANAN, Bangalore (IN); VENKATAVARADHAN DEVARAJAN, Bangalore (IN)

(21) Appl. No.: 15/023,009

(22) PCT Filed: Sep. 18, 2013
(86) PCT No.: PCT/IN2013/000565

§ 371 Date: Mar. 18, 2016

(51) Int. Cl. H04L 12/26; H04L 12/715; H04L 12/751

(52) U.S. Cl. CPC H04L 43/106; H04L 43/12; H04L 45/02; H04L 45/64

(57) ABSTRACT

Provided is a method of monitoring network performance characteristics. A first timestamp is added to a network probe packet at a first network device on a computer network. The network probe packet from the first network device is sent to a second network device on the computer network. A second timestamp is added to the network probe packet at the second network device. The network probe packet with the first timestamp and the second timestamp is forwarded to an OpenFlow controller on the computer network, wherein the OpenFlow controller determines the network performance characteristics of the computer network based on the first timestamp and the second timestamp.

### BACKGROUND

In Software-defined Networking (SDN) architecture the control plane is implemented in software separate from the network equipment and the data plane is implemented in the network equipment. OpenFlow is a leading protocol for SDN architecture. In OpenFlow network, data forwarding on a network device is controlled through flow table entries populated by an OpenFlow controller that manages the control plane for that network. A network device that receives packets on its interfaces looks up its flow table to check the actions that need to be taken on a received frame. By default an OpenFlow enabled network device creates a default flow table entry to send all packets that do not match any specific flow entry in the table to the OpenFlow Controller. In this manner, the OpenFlow controller becomes aware of all new network traffic coming in on a device and programs a flow table entry corresponding to a new traffic pattern on the receiver network device for subsequent packet forwarding of that flow.

### BRIEF DESCRIPTION OF THE DRAWINGS

For a better understanding of the solution, embodiments will now be described, purely by way of example, with reference to the accompanying drawings, in which:

FIG. 1 is a schematic block diagram of a network system based on Software-defined Networking (SDN) architecture, according to an example.

FIG. 2 shows a flow chart of a method, according to an example.

FIG. 3 is a schematic block diagram of an OpenFlow controller system hosted on a computer system, according to an example.

### DETAILED DESCRIPTION OF THE INVENTION

In a software defined networking paradigm with OpenFlow capable switches, a centralized software based controller application is aware of all the devices and their points of interconnection and manages the control plane for that network. OpenFlow technology de-couples data plane from the control plane in such a way that the data plane will reside on the switch while the control plane is managed on a separate device, commonly referred to as the SDN controller. Based on the control plane decisions, the forwarding rules are programmed on to the switches via the OpenFlow protocol. The switches consult this table when actually forwarding packets in data plane. Each forwarding rule has an action that dictates how traffic that matches the rule would need to be handled.

The controller typically learns of the network topology by having OpenFlow capable switches forward Link Layer Discovery Protocol (LLDP) advertisements received on their links (from peer switches) to the controller and thereby learning of all switches in the network and their points of interconnection. Note that the assumption here is that LLDP continues to run on the switches though it is also a control plane protocol. Alternatively, the topology can be statically fed into the controller by the administrator. Now the controller can run its choice of programs to construct a data path that connects every node in the network to every other node in the network as appropriate.xvg

When an application or user traffic enters the first OpenFlow capable (edge) switch, it looks up an OpenFlow data path table to see if the traffic matches any flow rule already programmed in the table. If the traffic does not match any flow rule, it is regarded as a new flow and the switch forwards it to the OpenFlow controller seeking inputs on how the frame needs to be forwarded by the switch. The controller then decides a forwarding path for the flow and sends the decision via the Open Flow protocol to the switch which in turn programs its data path table with this flow information and the forwarding action. Subsequent traffic matching this flow rule would be forwarded by the switch as per the forwarding decision made by the Open Flow controller.

The network performance characteristics (end-end latency, hop-hop latency, jitter and packet-loss) of an Open Flow or SDN based network need to be monitored actively for various reasons. There could be sub-optimal paths for certain types of traffic leading to increased end-end latencies or there could be congestion on some nodes causing packet drops or re-ordering of frames. The current network monitoring tools typically rely on the switches to measure transit delays, latency and drop rates. The traditional measurements are also resource hungry and so measurements are typically confined to select pair of end points and do not well lend themselves well to hop-hop measurements or measurements across any random pair of network end points. These capabilities are typically needed to drill down and understand the performance characteristics at finer granularity. Since existing tools rely heavily on the management and control plane of the networking gear (switches) to help make these measurements, they do not lend themselves well to the SDN paradigm where switches are expected to be forwarding engines with limited control and management intelligence.

The other problem with the traditional tools is that they are vendor proprietary and only work with their network gear. In a heterogeneous network with a mix of devices from different vendors, the administrators will have to use the different vendor provided tools to make these measurements making it hard to monitor the network from a single pane.

With the advent of BYOD (bring your own device) and other converged applications (like Microsoft Lync), the network not only carries data traffic but significant amount of multimedia traffic that are delay and loss sensitive. Given the dynamic nature of traffic patterns in the network, it is imperative for network administrators to actively measure and monitor network performance and take corrective action proactively.

Proposed is a solution for proactively measuring network performance characteristics in a computer network which is based on Software-defined Networking (SDN) architecture. Proposed solution uses an OpenFlow controller for measuring network performance characteristics in a SDN-based network. It applies a generic extension to the OpenFlow protocol and forwarding rule actions which helps switches participate in performance measurement activities initiated by an SDN controller while still maintaining their control and management layers lean.

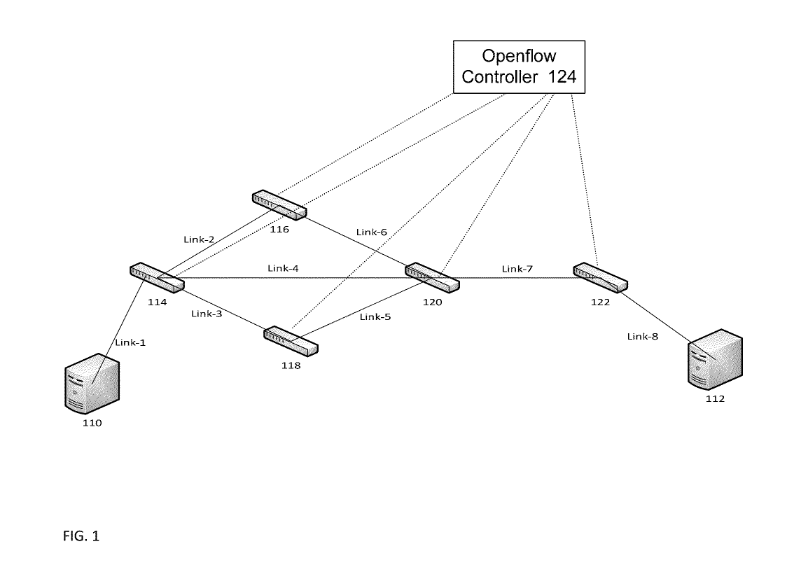

FIG. 1 is a schematic block diagram of a computer network system, according to an example.

Computer network system 100 includes host computer systems 110 and 112, network devices 114, 116, 118, 120, and 122, and OpenFlow controller 124. In an implementation, computer network system 100 is based on Software-defined Networking (SDN) architecture.

Host computer systems 110 and 112 are coupled to network devices 114 and 122 respectively. Host computer systems 110 (Host-1) and 112 (Host-2) may be a desktop computer, notebook computer, tablet computer, computer server, mobile phone, personal digital assistant (PDA), and the like. In an example, host computer systems 110 and 112 may include a client or multicast application for receiving multicast data from a source system (not illustrated) hosting multicast content.

OpenFlow controller 124 is coupled to network devices 114, 116, 118, 120, and 122, over a network, which may be wired or wireless. The network may be a public network, such as, the Internet, or a private network, such as, an intranet. The number of network devices 114, 116, 118, 120, and 122 illustrated in FIG. 1 is by way of example, and not limitation. The number of network devices deployed in a computer network system 100 may vary in other implementations. Similarly, computer network system may comprise any number of host computer systems in other implementations.

Network devices 114, 116, 118, 120, and 122 may include, by way of non-limiting examples, a network switch, a network router, a virtual switch, or a virtual router. In an implementation, network devices 114, 116, 118, 120, and 122 are Open-Flow enabled devices. Each network device 114, 116, 118, 120, and 122 may include an OpenFlow agent module for forwarding network probe packets generated by an OpenFlow (or SDN) application based on the forwarding rules and action set programmed on the network device. The action set may include selection of an output port for the probe packet and addition of a timestamp onto a frame before forwarding if instructed by OpenFlow controller 124.

OpenFlow controller system 124 is software (machine executable instructions) which controls OpenFlow logical switches via the OpenFlow protocol. More information regarding the OpenFlow controller can be obtained, for instance, from web links http://www.openflow.org/documents/openflow-spec-v1.0.0.pdf and https://www.opennetworking.org/images/stories/downloads/of-config/of-config-1.1.pdf. OpenFlow is an open standard communications protocol that gives access to the forwarding plane of a network switch or router over a network. It provides an open protocol to program a flow table in a network device (such as, a router) thereby controlling the way data packets are routed in a network. Through OpenFlow, the data and control logic of a network device are separated, and the control logic is moved to an external controller such as OpenFlow controller system 124. The OpenFlow controller system 124 maintains all of network rules and distributes the appropriate instructions to network devices 114, 116, 118, 120, and 122. It essentially centralizes the network intelligence, while the network maintains a distributed forwarding plane through OpenFlow-enabled network devices.

In an implementation, OpenFlow controller 124 includes a network performance monitoring module. The network performance monitoring module adds forwarding rules {flow match conditions, actions} on each switch to create network paths for traffic flow between a pair of network devices. The network performance monitoring module also monitors the network performance of the paths by sending and receiving special probe packets.

To provide an example in the context of an operational background, if host computer system 110 (Host-1) wants to communicate with host computer system (Host-2) 112, the data packets would flow through the computer network system 100 that comprises of network devices 114, 116, 118, 120, and 122. OpenFlow controller 124 becomes aware of the network topology (i.e. the set of network devices and their points of interconnection) prior to computing forwarding paths in network system 100. OpenFlow controller 124 then programs rules on each network device that would be used by the network device to forward packets from one network device to another. For instance, if host computer system 110 wants to send a traffic stream to host computer system 112, OpenFlow controller 124 could program the following rules on each switch (Table 1). It basically means that hosts computer systems (i.e. Host-1 and Host-2) connected to network 100 have to flow through OpenFlow controller 124 determined network path to communicate with one another.

TABLE 1

| | |
|---|---|
| Flow Match condition | Action |

Switch-114 Forwarding Rule

| | |
|---|---|
| DST-IP == Host-2 | Forward out Link-1 |

Switch-116 Forwarding Rule

| | |
|---|---|
| DST-IP == Host-2 | Forward out Link-6 |

Switch-120 Forwarding Rule

| | |
|---|---|
| DST-IP == Host-2 | Forward out Link-7 |

Switch-122 Forwarding Rule

| | |
|---|---|
| DST-IP == Host-2 | Forward out Link-8 |

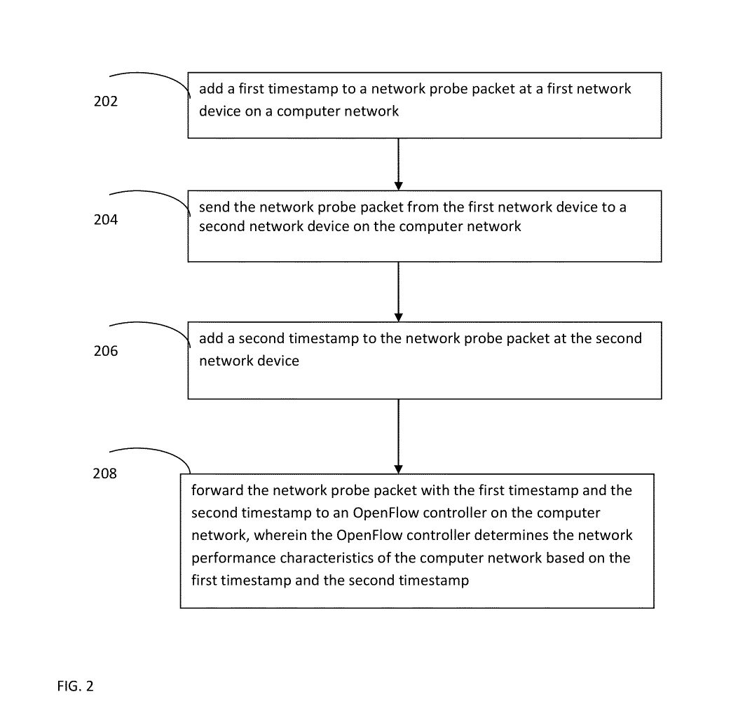

FIG. 2 shows a flow chart of a method of monitoring network performance characteristics in a computer network, according to an example. In an implementation, the method may be implemented in a software-defined computer network based on OpenFlow protocol. Details related to the OpenFlow protocol can be obtained from the web link https://www.opennetworking.org/standards/intro-to-openflow. During description references are made to FIG. 1 to illustrate the network performance characteristics monitoring mechanism.

In an implementation, it may be assumed that an OpenFlow controller (such as OpenFlow controller of FIG. 1) is aware of the network topology of a computer network system it is coupled to or a part of. Specifically, the OpenFlow controller is aware about the edge switches and transit switches present on the computer network. In the example topology illustrated in FIG. 1, network device 114 and network device 122 are edge switches and network devices 116, 118, and 120 are transit switches. Based on this knowledge, a network performance monitoring module on the OpenFlow controller may identify following possible paths between network device 114 and network device 122.
1. {Network device 114, Network device 116, Network device 120, Network device 122}
2. {Network device 114, Network device 120, Network device 122}
3. {Network device 114, Network device 118, Network device 120, Network device 122}

The network performance monitoring module may iteratively select a path and program forwarding rules on each network device in that path instructing the network devices to appropriately forward probe packets as and when they are received on their device interfaces. In an example, a network probe packet may be an Internet Protocol version 4 User Datagram Protocol (IPv4 UDP) frame that uses a reserved UDP Destination port to uniquely identify the frame in the network. The SRC-MAC and the DST-MAC of the frame would be the MAC addresses of the edge switches and the SRC-IP and DST-IP would be the IPv4 addresses of the edge switches. One of the values for the UDP port suggested here is 0xFF00 (65280) but a controller could use any of the UDP port values that are unused in the network. It may also be a value that an administrator can configure the controller application to use.

By way of an example, a sample probe packet sent from network device 114 to network device 122 may be as follows—

| DA-MAC = | SA-MAC = | | Payload |
|---|---|---|---|
| 122-MAC | 114-MAC | Length = 0 × 40 | (40 bytes) |
| 6 bytes | 6 bytes | 2 bytes | 40 bytes |

In this case, the payload of the frame as generated by the network performance monitoring module would be all O's. The UDP header checksum value would be set to O to indicate that the transmitting device does not want to use UDP checksums (given that UDP header checksum is an optional field in IPv4 networks). In an implementation, a new OpenFlow action type needs to be defined to support the network performance monitoring module and the action would be for the network device to write the device's current time value to an incoming packet's payload at an offset dictated by the OpenFlow controller.

Referring to FIG. 2, at block 202, a first timestamp is added to a network probe packet at a first network device on a computer network. The first timestamp may be added by an OpenFlow agent module present on the first network device. In an implementation, the first network device is an edge network device. However, in another implementation, it may be a transit network device. The first timestamp is added at a first location on the network probe packet and represents the current time on the first network device at the time of addition of the first timestamp. To provide an illustration in the context of FIG. 1, forwarding rules for Path-1 as programmed by a network performance monitoring module may be defined as follows—

### Network Device 114 Forwarding Rule

| Flow Match condition | Action | |
|---|---|---|
| DST-MAC == Network | 1. | Copy “switch's current time” value at |
| device 122-MAC | | PKT_OFFSET Ox2A (start of payload) |
| | 2. | Forward out Link-2 |

### Network Device 116 Forwarding Rule

| Flow Match condition | Action |
|---|---|
| DST-MAC == Network | Forward out Link-5 |
| device 122-MAC | |

### Network Device 120 Forwarding Rule

| Flow Match condition | Action |
|---|---|
| DST-MAC == Network | Forward out Link-6 |
| device 122-MAC | |

### Network Device 122 Forwarding Rule

| Flow Match condition | Action | |
|---|---|---|
| DST-MAC == Network | 1. | Copy “switch's current time” |
| device 122-MAC | | value at PKT_OFFSET Ox2E (4 bytes |
| | | from the start of payload) |
| | 2. | Copy to controller |

As illustrated above, an extra action is associated with the forwarding rules programmed on the edge network device. The extra action here is the requirement for the network device to write the current TIME to the PKT at the specific offset in the frame. Setting a timestamp at a certain location could be generalized to be of a Time-length-value (TLV) format with Type in this case being “SET TIME”, Length of data to write being “4 bytes” & Value being “O” indicates that the OpenFlow controller expects the network device to generate the value on its behalf for this type. By making it a TLV format, the OpenFlow action can be generalized to be of the form—
Action=‘Write Data To PKT’
Parameters=‘{Data To Write (TLV), Offset To Write At}’

Once generalized, the above action could also be specified multiple times with different {TLV, offset} pairs as needed by other applications outside the current scope.

At block 204, the network probe packet is sent from the first network device to a second network device on the computer network. In an implementation, the second network device is another edge device on the computer network. However, in another implementation, it may be a transit network device.

In the context of FIG. 1 example earlier, once the above mentioned set of forwarding rules have been programmed on all network devices, the network performance monitoring module on the OpenFlow controller sends out the above probe frame using the OpenFlow PKT_OUT construct. Network device 114 would consult its forwarding rules to decide on the action to be taken with regards to this frame. In an instance, it may include adding a timestamp at a location (for example, 0x2A) of the packet and forwarding it out link-2 to network device 116. A timestamp may be added by a software application on the network device, an application-specific integrated circuit (ASIC) or a network processor. Network device 116 and network device 120 would merely forward the probe packet out links Link-5 and Link-6 respectively.

At block 206, a second timestamp is added to the network probe packet at the second network device. In the above example, network device 122 would receive the network probe packet frame and add a timestamp at a second location which would be different from the first location. For example, this location could be Ox2E (4 bytes from the location where the first network device added its timestamp). The second timestamp represents the current time on the second network device at the time of addition of the second timestamp. In this case as well, the time stamping may be carried out by a software application on the network device, an application-specific integrated circuit (ASIC) or a network processor.

At block 208, the network probe packet with the first timestamp and the second timestamp is forwarded to an OpenFlow controller on the computer network, wherein the OpenFlow controller determines the network performance characteristics of the computer network based on the first timestamp and the second timestamp. The network performance monitoring module that receives the network probe frame analyses the timestamp added by the first network device and the timestamp added by the second network device, and uses the data (time values) to derive the network performance characteristics such as, but not limited to, network latency, jitter, end-to-end latency, hop-to-hop latency and packet loss of the network path. Blocks 202 to 208 can be repeated to determine the average latency and jitter of a network path. In an implementation, OpenFlow controller could probe further to understand hop-by-hop latency of this path ({network device 114→network device 116}, {network device 116→network device 120}, {network device 120→network device 122) by repeating blocks 202 to 208 to determine which hop is contributing the maximum delay. The whole exercise can be repeated on a different path to measure the latency and jitter of the other paths between the network devices on the computer network. The controller could probe further by monitoring hop-by-hop latency of each hop in the path. In another implementation, the same exercise can also be repeated for probe frames set with different values of 802.1p priorities or Differentiated Services Field Code points (DSCP) values to understand the latency characteristics for the different priority levels supported in the network.

By measuring the latency for different priorities or diffsery code points based path (using the probe packets), expected latency can be determined for real time traffic that may flow through these paths.

In order to measure frame loss on a network path, the controller may just periodically send probe packets with sequence numbers and have the origin switch forward the frame on the path and the destination switch copy the frame to the controller. The sequence numbers of the probe frames received at the controller could be used to determine the frame loss in the network. With the resultant information, the controller will be able to perform straight-forward calculation of network performance numbers such as delay, loss and jitter.

Proposed solution provides for a means to measure network performance characteristics with minimum control or management plane overhead on network devices (such as network switches). It takes away the complexity of maintaining measurement related statistics or states on the network devices.

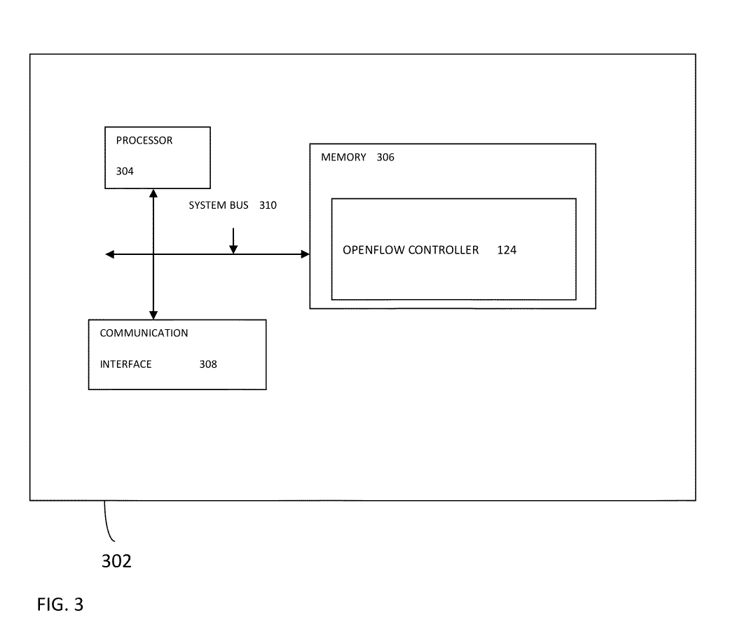

FIG. 3 is a schematic block diagram of an OpenFlow controller hosted on a computer system, according to an example.

Computer system 302 may include processor 304, memory 306, OpenFlow controller 124 and a communication interface 308. The components of the computing system 302 may be coupled together through a system bus 310.

Processor 304 may include any type of processor, microprocessor, or processing logic that interprets and executes instructions.

Memory 306 may include a random access memory (RAM) or another type of dynamic storage device that may store information and instructions non-transitorily for execution by processor 304. For example, memory 306 can be SDRAM (Synchronous DRAM), DDR (Double Data Rate SDRAM), Rambus DRAM (RDRAM), Rambus RAM, etc. or storage memory media, such as, a floppy disk, a hard disk, a CD-ROM, a DVD, a pen drive, etc. Memory 306 may include instructions that when executed by processor 304 implement OpenFlow controller 124.

Communication interface 308 may include any transceiver-like mechanism that enables computing device 302 to communicate with other devices and/or systems via a communication link. Communication interface 308 may be a software program, a hard ware, a firmware, or any combination thereof. Communication interface 308 may use a variety of communication technologies to enable communication between computer system 302 and another computer system or device. To provide a few non-limiting examples, communication interface 308 may be an Ethernet card, a modem, an integrated services digital network (“ISDN”) card, etc.

OpenFlow controller 124 may be implemented in the form of a computer program product including computer-executable instructions, such as program code, which may be run on any suitable computing environment in conjunction with a suitable operating system, such as Microsoft Windows, Linux or UNIX operating system. Embodiments within the scope of the present solution may also include program products comprising computer-readable media for carrying or having computer-executable instructions or data structures stored thereon. Such computer-readable media can be any available media that can be accessed by a general purpose or special purpose computer. By way of example, such computer-readable media can comprise RAM, ROM, EPROM, EEPROM, CD-ROM, magnetic disk storage or other storage devices, or any other medium which can be used to carry or store desired program code in the form of computer-executable instructions and which can be accessed by a general purpose or special purpose computer.

In an implementation, OpenFlow controller 124 may be read into memory 306 from another computer-readable medium, such as data storage device, or from another device via communication interface 308.

For the sake of clarity, the term “module”, as used in this document, may mean to include a software component, a hardware component or a combination thereof. A module may include, by way of example, components, such as software components, processes, tasks, co-routines, functions, attributes, procedures, drivers, firmware, data, databases, data structures, Application Specific Integrated Circuits (ASIC) and other computing devices. The module may reside on a volatile or non-volatile storage medium and configured to interact with a processor of a computer system.

It would be appreciated that the system components depicted in FIG. 3 are for the purpose of illustration only and the actual components may vary depending on the computing system and architecture deployed for implementation of the present solution. The various components described above may be hosted on a single computing system or multiple computer systems, including servers, connected together through suitable means.

It should be noted that the above-described embodiment of the present solution is for the purpose of illustration only. Although the solution has been described in conjunction with a specific embodiment thereof, numerous modifications are possible without materially departing from the teachings and advantages of the subject matter described herein. Other substitutions, modifications and changes may be made without departing from the spirit of the present solution.

We claim:

1. A method of monitoring network performance characteristics, comprising:
adding a first timestamp to a network probe packet at a first network device on a computer network;
sending the network probe packet from the first network device to a second network device on the computer network;
adding a second timestamp to the network probe packet at the second network device; and
forwarding the network probe packet with the first timestamp and the second timestamp to an OpenFlow controller on the computer network, wherein the OpenFlow controller determines the network performance characteristics of the computer network based on the first timestamp and the second timestamp.

2. The method of claim 1, wherein the first timestamp is added at a first location of the network probe packet and the second timestamp is added at a second location of the network probe packet.

3. The method of claim 1, wherein the first timestamp represents current time on the first network device while adding the first timestamp at the first network device and the second timestamp represents current time on the second network device while adding the second timestamp at the second network device.

4. The method of claim 1, wherein the network performance characteristics include one of: network latency, jitter, end-to-end latency, hop-to-hop latency and packet loss.

5. The method of claim 1, wherein the computer network is based on Software Defined Networking (SDN) architecture.

6. The method of claim 1, wherein the first network device is an originating edge device or a transit device and the second network device is a destination edge device or a transit device.

7. The method of claim 1, wherein the first network device and the second device are present on a network path selected by the OpenFlow controller.

8. The method of claim 1, wherein the first timestamp and the second time stamp are added at specific offsets in the network packet and are in a Time-length-value (TLV) format.

9. A system for monitoring network performance characteristics of a computer network, comprising:
a first network device to add a first timestamp to a network probe packet at a first location;
a second network device to receive the network probe packet with the first timestamp from the first network device and add a second timestamp to the network probe packet at a second location; and
an OpenFlow controller to receive the network probe packet with the first timestamp and the second timestamp from the second network device, wherein the OpenFlow controller determines the network performance characteristics of the computer network based on values of the first timestamp and the second timestamp.

10. The system of claim 9, wherein the network device is a network switch or router.

11. The system of claim 9, wherein the network device is a virtual device.

12. The system of claim 9, wherein the network probe packet is generated by the OpenFlow controller.

13. The system of claim 9, wherein the network probe packet is configured with different values of priorities to determine latency characteristics for different priority levels supported in the computer network.

14. A computer system, comprising:
an OpenFlow controller to:
receive a network probe packet with a first timestamp and a second timestamp from a destination edge switch on a computer network,
wherein the first timestamp is added to the network probe packet at an originating edge switch or a transit switch and the second timestamp is added to the network probe packet at the destination edge switch or another transit switch,
wherein the destination edge switch or the another transit switch receives the network probe packet with the first timestamp from the originating edge switch or the transit switch,
wherein the OpenFlow controller determines network performance characteristics of the computer network based on the first timestamp and the second timestamp.

15. A non-transitory processor readable medium, the non-transitory processor readable medium comprising machine executable instructions, the machine executable instructions when executed by a processor causes the processor to:
add a first timestamp to a network probe packet at a first network device on a computer network;
send the network probe packet from the first network device to a second network device on the computer network;
add a second timestamp to the network probe packet at the second network device; and
forward the network probe packet with the first timestamp and the second timestamp to an OpenFlow controller on the computer network, wherein the OpenFlow controller determines the network performance characteristics of the computer network based on the first timestamp and the second timestamp.
